(19) United States
(12) Patent Application Publication
(10) Pub. No.: US 2023/0222937 A1
(43) Pub. Date: Jul. 13, 2023

(54) Online Mobile Chinese Learning Resource Platform

(71) Applicant: Xiao Ping LIN, Hong Kong (CN)

(72) Inventor: Xiao Ping LIN, Hong Kong (CN)

(21) Appl. No.: 18/150,209

(22) Filed: Jan. 5, 2023

(30) Foreign Application Priority Data
Jan. 10, 2022 (HK) HK22022046000.4

(51) Int. Cl. G09B 17/04; G09B 7/02

(52) U.S. Cl. CPC G09B 17/04; G09B 7/02

(57) ABSTRACT

The invention discloses an online mobile Chinese learning resource platform, comprising a client end and a server, the client end is in communication connection with the server, the server being used to store teaching resource and user information, the server comprising children park system, online testing system, online learning system, online evaluation system and Chinese online reading international invitation activity system, online mobile Chinese learning international symposium system, Chinese online fast reading essay exhibition review after reading Yao Zongyi's work, classic masterpiece silent typing etc. all platform system. The system can be integrated, can be dedicated feasible and effective, spreadable, can be promoted, and sustainable.

### CROSS REFERENCE TO RELATED APPLICATIONS

This application claims priority to, and the benefit of, Hong Kong Original Grant Patent Application Serial No. HK 22022046000.4 filed on 10 Jan. 2022, entitled Online Mobile Chinese Learning Resource Platform. The entire contents of the foregoing applications are hereby incorporated by reference for all purposes.

### TECHNICAL FIELD

The invention relates to the technical field of Internet teaching, and in particular, to a latitude digital online mobile innovation mode Chinese learning resource platform (innovation mode) of Chinese online identification, online reading, online evaluation, and online writing.

### BACKGROUND

The era of knowledge economy is also the era of education. Education, as a means for developing human resources, cultivates high-tech talents on which the knowledge economy depends. The application of scientific and technological knowledge represented by high technologies and the development of human resources represented by human intelligence (that is, education) are the two pillars of the knowledge economy.

With the increasing development and updating of network technologies, the online education mode emerges, such as the Mooc mode, the horizontal course platform mode, flipped classroom, and blended learning. For example, although a mode emphasizes self-study and self-help, the online education mode that is presumably close to teacher teaching is still traditional teaching of “I tell and you listen”.

To sum up, the real education is to let students learn actively. Exploring how to guide students to achieve active learning currently has become the focus of colleagues in the education sector.

### SUMMARY

The purpose of the invention is to solve the shortcomings of the prior art, and proposes a latitude digital online mobile innovation mode Chinese learning resource platform (innovation mode), that is, an innovative learning platform and innovation mode based on internet.

In order to achieve the above purpose, the invention adopts the following technical solutions:

A latitude digital online mobile innovation mode Chinese learning resource platform (innovation mode), where an innovative learning platform and innovation mode based on internet includes a client end and a server. The client end is in communication connection with the server, the server is configured to store teaching resource and user information, the server includes a children park system, an online testing system, an online learning system, an online evaluation system, and a Chinese online reading international invitation activity system;
the children park system is configured to provide online learning for children;
the online testing system is configured to perform human-computer interaction to learn Chinese characters;
the online learning system is configured to improve the concentration of a learner, and train the capability of the eyes of the learner for fast and efficiently capturing text information; the online learning system includes an online reading system and an online writing system, the online learning system is provided with a left dragging mode, a right typing mode, an answering mode, and a writing mode, the left dragging mode includes a selection mode, a dragging black mode, and a turning green mode, and the left typing mode includes a digital mode, an enter mode, and a mode of combining characters into a sentence; and
the Chinese online reading international invitation activity system is configured to improve the fast reading capability of a user.

In the online learning system, javascript is used to dynamically monitor mouse movements of a reader. If the reader's mouse selects a text and then clicks on “ok”, the program automatically uses a regular expression to perform technical detection on the selected text. It is required that the page text needs to match a text stored in a database, and a green feedback is displayed. Otherwise, “Please select the smallest segment” is prompted to indicate re-operation, that is, create an active online reading process of “select . . . drag black . . . turn green”.

This solves the technical problem of undetectability of “eyes and reading content” in the history of reading. Based on the common network programming language java, according to a computer mouse action, javascript is used to dynamically monitor and integrate, and detection-match-feedback-prompt are combined, to achieve a controllable online operating system.

In the reading operation mode of “drag left . . . type right” and “answer . . . write”, first, “eyes, brains, and hands coordinate-fast reading while not viewing and typing while viewing” are designed to train to increase a visual breadth and an identification distance, to improve reading efficiency. Second, a special function of customized automatic encoding of a specific system is fully used to improve the reading concentration and the reading speed during acquisition. Third, reading comprehension exercises combined with intensive reading and extensive reading of passages can improve the reading comprehension rate. The purpose is to cultivate the ability of learners to read actively and fast, the willingness to read, and the proficiency in reading.

Preferably, the children park system includes a joyful learning digital mode, a joyful exercise block mode, and a joyful E-reading mode, and in the joyful learning digital mode, the joyful exercise block mode, and the joyful E-reading mode, a Chinese character is learned by clicking on a button with a mouse.

Preferably, the online testing system includes a system for identifying a character with code, and the system for identifying a character with code includes a seven-step mode of identifying a character with code.

Preferably, the seven-step mode of identifying a character with code includes reading an example, encoding, memorizing, listening sound, interpretation, sentence making, and searching, the seven-step mode of identifying a character with code implements improved and active learning of Chinese characters, a learning system for identifying a Chinese character with code is designed according to three main elements of Chinese characters: shape, sound, and meaning, and the identifying a character with code is a learning process combining Chinese identification and an active learning capability and adds a psychological element of “memorizing-retention-recall-reproduction”.

Preferably, the online learning system includes an exercise module and a self-reward plan module, the exercise module is configured to perform real-time exercise without a score record, and the self-reward plan module is configured to perform real-time exercise with a score record.

Preferably, the online learning system includes an online reading system and an online writing system, the online reading system includes three different modes: exercise, test, and text transmission, includes different learning levels for different age groups: children, primary school, middle school, and college, and also includes settings for classical poetry, modern poetry, and famous quotes, the online reading system is provided with record and comparison of self-test scores of reading speeds, the online writing system is an open system based on internet for different learning groups to write at the same time, and provides teachers with a simple and fast online composition review system, the online writing system includes three parts: a writing login system, a management confirmation system, and an online review system, and the online writing system includes a personal exercise version, an online test version, a teacher review version, and a personal picture transmission version.

Preferably, the online learning system includes a five-step third-stage customized mode, and five steps in the five-step third-stage customized mode includes: step 1: choosing an example, step 2: defining code, step 3: combining characters and combining sentences, step 4: fast reading, and step 5: online learning system, and third stages in the five-step third-stage customized mode includes: stage 1: defining storage, stage 2: text typing while viewing, and stage 3: extracting information.

Preferably, the Chinese online reading international invitation activity system includes an exercise channel, a test channel, a competition channel, score statistics collection, an online mobile innovation mode Chinese learning international symposium system, and a Chinese online fast reading essay exhibition review after reading Yao Zongyi's work, and each of the exercise channel, the test channel, and the competition channel includes an exhibition and evaluation channel.

Preferably, the exhibition and evaluation channel includes ancient poetry typing while not viewing, interesting idiom, online reading, and post-reading essay, the exhibition and evaluation channel includes rules of online different places and different times, independent completion with references, self-selected chapter content, keyboard mode selection, traditional and simplified method selection, a fixed time and an unfixed quantity, and no score upper limit, a mouse movement of a reader is dynamically monitored, and an active online reading process of “selecting-dragging black-turning green” is created.

Preferably, the server is provided with a user login module and a password management module.

The beneficial effects of the invention are:

1. Under the premise of “joyful learning and active exploration”, eyes, brains, and hands of learners can coordinate. Through acquisition, learners can know, improve, and subtly master skills.

2. Learners can acquire Chinese in an internet innovative learning platform. Through the process of “identifying characters-reading-writing” and language ability development, learners can develop skills and intelligent potential for harmonious development.

3. Learners can fully improve independence, exploration, and cooperation in online innovative learning, so as to actively acquire knowledge and skills, discover, analyze, and solve problems, comprehensively develop emotions, attitudes, values, and innovative spirit, and promote cultivation of creative talents.

In the latitude digital online mobile innovation mode Chinese learning resource platform (innovation mode), the innovative learning platform and scientific and technological innovation are the same in that, it is feasible, sensible, controllable, operable and detectable, many years of experiments, multiple scientific research tests, online participant, teacher, and parent questionnaire and interviews, and data comparison can prove the process method system can be feasible and effective, spreadable, can be promoted, and sustainable.

### BRIEF DESCRIPTION OF THE ACCOMPANYING DRAWINGS

FIG. 1 is a structural principle diagram of a latitude digital online mobile innovation mode Chinese learning resource platform (innovation mode), that is, an innovative learning platform and innovation mode based on internet according to the invention;

FIG. 2 is a structural principle diagram of a server according to the invention;

FIG. 3 is a structural principle diagram of a children park system according to the invention;

FIG. 4 is a structural principle diagram of an online testing system according to the invention;

FIG. 5 is a structural principle diagram of an online learning system according to the invention;

FIG. 6 is a structural principle diagram of a Chinese online reading international invitation activity system according to the invention;

FIG. 7 is a structural principle diagram of an exhibition and evaluation channel according to the invention; and

FIG. 8 is a schematic structural diagram of an innovation mode according to the invention.

### DETAILED DESCRIPTION OF THE EMBODIMENTS

The following clearly and completely describes the technical solutions in the embodiments of the invention with reference to accompanying drawings in the embodiments of the invention. Apparently, the described embodiments are merely a part rather than all of the embodiments of the invention.

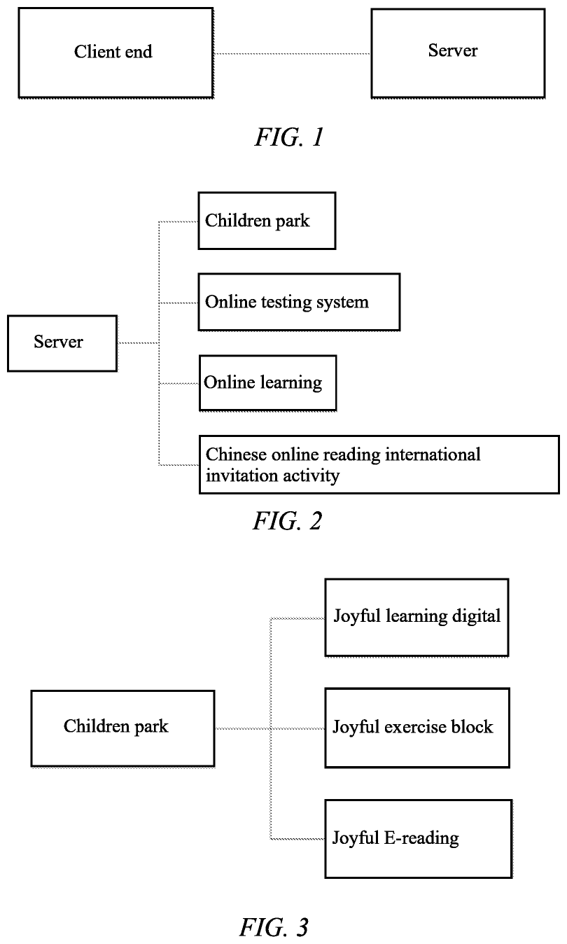

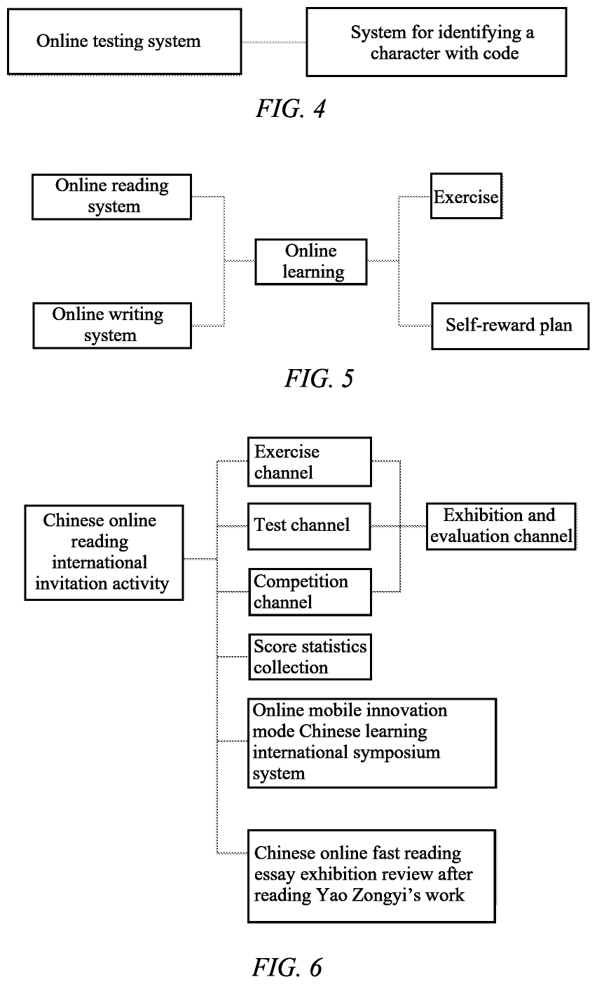

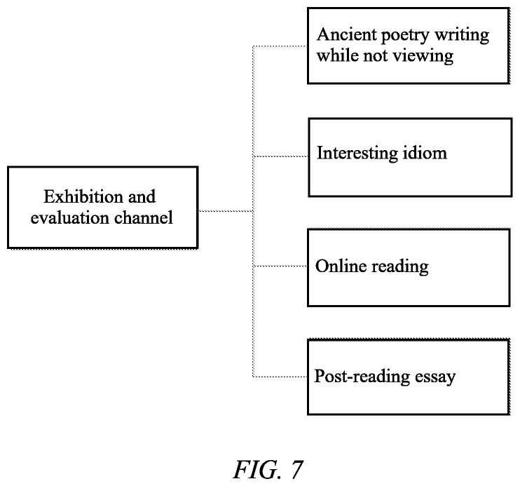

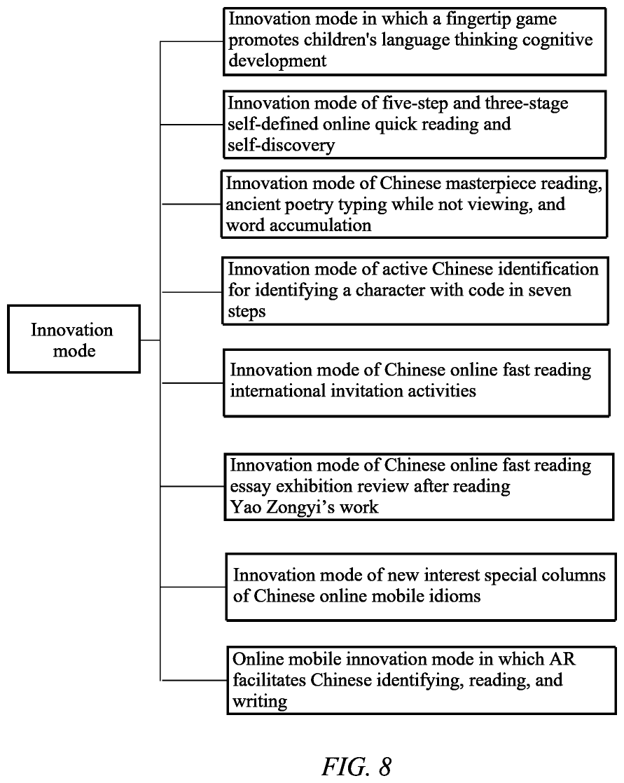

Referring to FIG. 1 to FIG. 8, an innovative learning platform and innovation mode based on internet includes a client end and a server. The client end is in communication connection with the server, the server is configured to store teaching resource and user information, and the server includes a children park system, an online testing system, an online learning system, and a Chinese online reading international invitation activity system; where

the children park system is configured to provide online learning for children;
the online testing system is configured to perform human-computer interaction to learn Chinese characters;
the online learning system is configured to improve the concentration of a learner, and train the capability of the eyes of the learner for fast and efficiently capturing text information; the online learning system includes an online reading system and an online writing system, the online learning system is provided with a left dragging mode, a right typing mode, an answering mode, and a writing mode, the left dragging mode includes a selection mode, a dragging black mode, and a turning green mode, and the left typing mode includes a digital mode, an enter mode, and a mode of combining characters into a sentence; and
the Chinese online reading international invitation activity system is configured to improve the reading capability of a user.

Further, the children park system includes a joyful learning digital mode, a joyful exercise block mode, and a joyful E-reading mode. Joyful learning digital, joyful exercise block, and joyful E-reading fingertip games are combined with content such as children emotions, society, health, and language, to guide children to actively participate and carry out early reading easily, joyfully, and effectively. According to needs and interests of children development, a comprehensive, open, and flexible formal or informal mode is used, so that children can learn joyfully and cultivate their curiosity and enhance their interest in identifying Chinese characters in an imperceivable process of “clicking on a button with a mouse” in fingertip games in which hands, eyes, and brains of children coordinate, to satisfy children's desire to identify Chinese characters actively, improve their thinking and cognitive abilities, and promote children comprehensive development. Therefore, children can cultivate curiosity and enhance their interest and love for identifying Chinese characters in fingertip games under the combined action of feeling, hearing, and touch through the process of “seeing-correcting-distinguishing-moving fingers-correcting errors”.

Further, the online testing system includes a system for identifying a character with code, and the system for identifying a character with code includes a seven-step mode of identifying a character with code.

Further, the seven-step mode of identifying a character with code includes reading an example, encoding, memorizing, listening sound, interpretation, sentence making, and searching, and the seven-step of identifying a character with code implements improved learning of Chinese characters. Participants can choose to learn and accumulate idioms according to a program at any time, or choose how many steps to take or which step to take first according to their own actual case. The score of participants is released in real time by a system automatic counting function, which is conducive to mutual competition between participants and improvement of active learning. Learning attraction for “identifying a Chinese character with code” is designed according to three main elements of Chinese characters: shape, sound, and meaning, and the identifying a character with code is a learning process combining Chinese identification and an active learning capability and adds a psychological element of “memorizing-retention-recall-reproduction”, to analyze the psychological characteristics of different learners, and implement “identifying the shape”-“listening and identifying the sound”-“comprehending the meaning” in an online or mobile case and “trying to apply”-“learning to expand” in the platform. The process of desirable acquisition of Chinese characters is completed in “coordinated usage of eyes, brains, and hands”.

Further, the online learning system includes an exercise module and a self-reward plan module. The exercise module is configured to perform real-time exercise without a score record, and the self-reward plan module is configured to perform real-time exercise with a score record. Participants win by being proficient in content and skills. As soon as the time set in the system is up, the page displays the score. If there are multiple rounds, the system accumulates scores and displays the dynamic changes of the ranking of individual scores in each school, each category, and each group. A self-reward mode is used, a score is actively inquired, and competition is performed, to promote students to actively and easily enter random ubiquitous online mobile innovative learning anytime and anywhere. The online learning system includes a five-step third-stage customized mode, and the five-step third-stage customized mode includes: step 1: choosing an example, step 2: defining code, step 3: combining characters and combining sentences, step 4: fast reading, and step 5: online learning system, stage 1: defining storage, stage 2: text typing while viewing, and stage 3: extracting information and implementing the online learning system step by step according to a program. The online learning system mainly includes an online reading system and an online writing system. The online reading system includes three different modes: exercise, test, and text transmission, includes different learning levels for different age groups: children, primary school, middle school, and college, and also includes settings for different content of classical poetry, modern poetry, and famous quotes. Besides, the online reading system is provided with record and comparison of self-test scores of reading speeds, to facilitate learners to control their own process and efficiency. The online writing system is an open system based on Internet for different learning groups to write at the same time, and provides teachers with a simple and fast online composition review system, the online writing system includes three parts: a writing login system, a management confirmation system, and an online review system, and the online writing system includes a personal exercise version, an online test version, a teacher review version, and a personal picture transmission version.

Further, the Chinese online reading international invitation activity system includes an exercise channel, a test channel, a competition channel, and score statistics collection, and each of the exercise channel, the test channel, and the competition channel includes an exhibition and evaluation channel. The exhibition and evaluation channel includes ancient poetry typing while not viewing, interesting idiom, online reading, and post-reading essay. Participants can perform ancient poetry typing while not viewing in a familiar manner. Since the time of ancient poetry typing while not viewing is fixed and a quantity of ancient poetry typing while not viewing is not fixed, participants win by being proficient in content and skills. As soon as the time set in the system is up, the page displays the score. If there are multiple rounds, the system accumulates scores and displays the dynamic changes of the ranking of individual scores in each school, each category, and each group. A self-reward mode is used, a score is actively inquired, and competition is performed, to promote students to actively and easily enter random online mobile innovative learning anytime and anywhere. This solves the technical problem of undetectability of “eyes and reading content” in the history of reading and autonomously adjusts improvement of a reading speed. After requirements and target functions are planned, javascript is technically used to dynamically monitor mouse movements of a reader. If the reader's mouse selects a text, the program automatically uses a regular expression to perform technical detection on the selected text. It is required that the page text needs to match a text stored in a database, and a green feedback is displayed. Otherwise, “Please select the smallest segment” is prompted to indicate re-operation, that is, create an independent online reading process of “select . . . drag black . . . turn green”.

Further, the server is provided with a user login module and a password management module, and the user login module and the password management module are configured to manage users.

In this embodiment, the learning platform is a network service built on internet, and provides an autonomous, layered, open, and integrated online system for participating in the exploration and research experiment of organically combining Chinese language learning and teaching. The learning platform has a graphical and intuitive interface and an interactive exercise that are browsable, easy to access and operate, and joyful to learn. The system sets up functions such as automatic score statistics collection. Web pages are sequentially formed according to specific content and system links. In this learning platform, under the premise of “joyful learning and active exploration”, eyes, brains, and hands of learners can coordinate. Through acquisition, learners can know, improve, and subtly master skills. In this learning platform, learners can acquire Chinese in an internet innovative learning platform. Through the process of “identifying characters-reading-writing” and language ability development, learners can develop skills and intelligent potential for harmonious development. In this learning platform, learners can fully improve independence, exploration, and cooperation in online innovative learning, so as to actively acquire knowledge and skills, discover, analyze, and solve problems, comprehensively develop emotions, attitudes, values, and innovative spirit, and promote cultivation of creative talents. The innovative learning platform and scientific and technological innovation are the same in that, it is feasible, sensible, controllable, operable and detectable, many years of experiments prove that the process method system can be feasible and effective, spreadable, can be promoted, and sustainable.

The above descriptions are only preferred specific implementations of the invention, but the protection scope of the invention is not limited thereto. Any equivalent variation or replacement readily figured out by a person skilled in the art according to the technical solutions and inventive concept of the invention within the technical scope disclosed in the invention shall fall within the protection scope of the invention.

1. An online mobile Chinese learning resource platform, comprising a client end and a server, wherein the client end is in communication connection with the server, the server is configured to store teaching resource and user information, the client end comprises a children park system, an online testing system, an online learning system, an online evaluation system, and a Chinese online reading international invitation activity system;
the children park system is configured to provide online learning for children;
the online testing system is configured to perform human-computer interaction to learn Chinese characters;
the online learning system is configured to improve the concentration of a learner, and train the capability of the eyes of the learner for fast and efficiently capturing text information; the online learning system comprises an online reading system and an online writing system, the online learning system is provided with a left dragging mode, a right typing mode, an answering mode, and a writing mode, the left dragging mode comprises a selection mode, a dragging black mode, and a turning green mode, and the left typing mode comprises a digital mode, an enter mode, and a mode of combining characters into a sentence; and
the Chinese online reading international invitation activity system is configured to improve the fast reading capability of a user.

2. The platform according to claim 1, wherein the children park system comprises a joyful learning digital mode, a joyful exercise block mode, and a joyful E-reading mode, and in the joyful learning digital mode, the joyful exercise block mode, and the joyful E-reading mode, a Chinese character is learned by clicking on a button with a mouse.

3. The platform according to claim 1, wherein the online testing system comprises a system for identifying a character with code, and the system for identifying a character with code comprises a seven-step mode of identifying a character with code.

4. The platform according to claim 3, wherein the innovative learning platform and innovation mode based on internet is characterized by that: the seven-step mode of identifying a character with code comprises reading an example, encoding, memorizing, listening sound, interpretation, sentence making, and searching, the seven-step mode of identifying a character with code implements improved and active learning of Chinese characters, a learning system for identifying a Chinese character with code is designed according to three main elements of Chinese characters: shape, sound, and meaning, and the identifying a character with code is a learning process combining Chinese identification and an active learning capability and adds a psychological element of “memorizing-retention-recall-reproduction”.

5. The platform according to claim 1, wherein the online learning system comprises an exercise module and a self-reward plan module, the exercise module is configured to perform real-time exercise without a score record, and the self-reward plan module is configured to perform real-time exercise with a score record.

6. The platform according to claim 1, wherein the online reading system comprises three different modes: exercise, test, and text transmission, comprises different learning levels for different age groups: children, primary school, middle school, and college, and also comprises settings for classical poetry, modern poetry, and famous quotes, the online reading system is provided with record and comparison of self-test scores of reading speeds, the online writing system is an open system based on internet for different learning groups to write at the same time, and provides teachers with a simple and fast online composition review system, the online writing system comprises three parts: a writing login system, a management confirmation system, and an online review system, and the online writing system comprises a personal exercise version, an online test version, a teacher review version, and a personal picture transmission version.

7. The platform according to claim 5, wherein the online learning system comprises a five-step third-stage customized mode, and five steps in the five-step third-stage customized mode comprises: step 1: choosing an example, step 2: defining code, step 3: combining characters and combining sentences, step 4: fast reading, and step 5: online learning system, and third stages in the five-step third-stage customized mode comprises: stage 1: defining storage, stage 2: text typing while viewing, and stage 3: extracting information.

8. The platform according to claim 1, wherein the Chinese online reading international invitation activity system comprises an exercise channel, a test channel, a competition channel, score statistics collection, an online mobile innovation mode Chinese learning international symposium system, and a Chinese online fast reading essay exhibition review after reading Yao Zongyi's work, and each of the exercise channel, the test channel, and the competition channel comprises an exhibition and evaluation channel.

9. The platform according to claim 7, wherein the exhibition and evaluation channel comprises ancient poetry typing while not viewing, interesting idiom, online reading, and post-reading essay, the exhibition and evaluation channel comprises rules of online different places and different times, independent completion with references, self-selected chapter content, keyboard mode selection, traditional and simplified method selection, a fixed time and an unfixed quantity, and no score upper limit, and no score upper limit, a mouse movement of a reader is dynamically monitored, and an active online reading process of “selecting-dragging black-turning green” is created.

10. The platform according to claim 1, wherein the server is provided with a user login module and a password management module.

11. (canceled)
